(19) United States
(12) Patent Application Publication
(10) Pub. No.: US 2026/0169944 A1
(43) Pub. Date: Jun. 18, 2026

(54) BRIDGE MODULE, UART EXPANSION DEVICE, AND METHOD OF SHOWING CUSTOMIZED SERIAL PORT NAME

(71) Applicant: PROLIFIC TECHNOLOGY INC., Taipei City (TW)

(72) Inventors: JUNG-HSIN YEH, Taipei City (TW); YU-HSUAN YEH, Taipei City (TW)

(73) Assignee: PROLIFIC TECHNOLOGY INC., Taipei City (TW)

(21) Appl. No.: 19/411,494

(22) Filed: Dec. 8, 2025

(30) Foreign Application Priority Data
Dec. 13, 2024 (TW) 113148552

(51) Int. Cl. G06F 13/40; G06F 13/42

(52) U.S. Cl. CPC G06F 13/4027; G06F 13/4221; G06F 13/4286; G06F 2213/0002; G06F 2213/0026; G06F 2213/0042; G06F 2213/40

(57) ABSTRACT

A bridge module is disclosed, and comprises a bridge electronic chip and a memory, of which the memory is wrote with a customized serial port name therewithin. The bridge module can be applied in a UART expansion device like USB-RS232 conversion device. As such, when the UART expansion device is electrically connected to a host electronic device been installed with a corresponding driver of the UART expansion device, the bridge electronic chip reads out the customized serial port name from the memory, and integrates the customized serial port name in a device descriptor, thereby transmitting the device descriptor to the host electronic device. As a result, a device manager of an operating system (e.g., Windows) of the host electronic device shows at least one UART port of the UART expansion device by the customized serial port name.

### CROSS-REFERENCE TO RELATED APPLICATIONS

This This application claims the priority and benefit of Taiwan patent application No. 113148552, filed on Dec. 13, 2024, the entire contents of which are incorporated herein by reference.

### BACKGROUND OF THE INVENTION

### 1. Field of the Invention

The present invention relates to the technology filed of serial port (or called as COM port), and more particularly, to a method of showing customized serial port name, in which the method is conducted by an electronic device.

### 2. Description of the Prior Art

It is known that UART interface like a RS232 connector is one kind of data transmission interface installed in a personal computer in the early years, such that the processor of the personal computer is able to communicate with at least one kind of peripheral device through the UART interface. However, because of including particular characteristics of Plug and Play (PnP) and high data transfer speed, USB interface is hence becoming the principal data transmission interface installed in various personal computers such as desktop computer and laptop computer in recent years.

In spite of the forgoing fact, UART interface is still applied in industrial control nowadays. Accordingly, USB device manufactures develop so as to roll out multiple types of external USB-UART conversion device and UART expansion cards (or called serial port expansion card), of which the USB-UART conversion device includes a USB connector for use in connection with one USB connector of a personal computer, and the UART expansion card has a PCIe interface (i.e., golden fingers) for being inserted into a PCIe slot that is disposed on a mother board of the personal computer. For example, FIG. 1 shows a stereo diagram of the USB-UART conversion device 1a, and FIG. 2 illustrates a stereo diagram of the UART expansion card 1b. As FIG. 1 and FIG. 2 show, the USB-UART conversion device 1a includes a bridge IC 10a, and the UART expansion card 1b also has a bridge IC 10b.

User who has experience of using the USB-UART conversion device 1a of FIG. 1 (or the UART expansion card 1b of FIG. 2) certainly know that, a standard CDC-ACM driver provided by Microsoft Corporation is employed as a standard device driver of the USB-UART conversion device 1a. Therefore, the user still needs to install the standard device driver in his personal computer after firstly connecting the USB connector 11a of the USB-UART conversion device 1a to one USB connector of the personal computer. Consequently, as FIG. 3 shows, in a user interface of a device manager of an operating system of the personal computer it can see that the three RS232 ports 12a of the USB-UART conversion device 1a are all named as USB serial port, and the device manager assigns the three RS232 ports 12a corresponding serial port numbers of 3, 4, 5.

In practical, manufacturer would commonly develop so as to provide, based on the standard CDC-ACM driver, a manufacturer-developed device driver of the USB-UART conversion device 1a of FIG. 1 (or the UART expansion card 1b of FIG. 2). In other words, there is also an option for the user to install the manufacturer-developed device driver in his personal computer after firstly connecting the USB connector 11a of the USB-UART conversion device 1a to one USB connector of the personal computer. Therefore, as FIG. 4 shows, in the user interface of the device manager it can see that the three RS232 ports 12a of the USB-UART conversion device 1a are all named as “Prolific PL2303GC USB Serial COM Port”, and the device manager assigns the three RS232 ports 12a corresponding serial port numbers of 3, 4, 5.

To be more specific, since the manufacturer-developed device driver is one kind of USB device driver, which is commonly developed by the manufacturer (i.e., design house) of the bridge IC 10a. Moreover, software engineers certainly know that the USB device driver comprises a *.inf file and a *.sys file, of which the *.sys file includes the principal driver instructions, and the *.inf is a device information file for use in guiding the operating system of the personal computer to run the whole install procedure of the USB device driver. In addition, software engineers also know that there is an instruction section named as “Strings” planned and edited in the *.inf file, and the USB device's VID and PID are listed in this instruction section, such that the operating system can read the *.inf file so as to acquire the USB device's VID and PID while running the install procedure of the USB device driver. For example, in FIG. 4 “Prolific” and “PL2303GE” are VID and PID of the bridge IC 10a, respectively.

Practical experience has revealed that, supplier who is not also the manufacturer of the bridge IC 10a is unable to make the device manager show the USB device (e.g., the USB-UART conversion device) by a supplier name and/or a specific name through revising VID and/or PID listed in the “Strings” section of the *.inf file. The reason is that the manufacturer-developed device driver further comprises a *.cat file, which is a digitally signed catalog file used as a digital signature for the manufacturer-developed device driver package. Particularly, the catalog file contains cryptographic hashes or thumbprints, and each thumbprint corresponds to a file that the driver package installs. To be more specific, USB device installation considers the digital signature of the USB device driver package (e.g., the manufacturer-developed device driver package) to be invalid if any file in the USB device driver package is altered after the USB device driver package was signed. Such files include the *.inf file, the *.cat file, and all files that are copied by INF CopyFiles directives. For example, even a single-byte change to correct a misspelling invalidates the digital signature. If the digital signature is invalid, it must either resubmit the USB device driver package to the Windows Hardware Dev Center for a new signature, or generate a new Authenticode signature for the USB device driver package. On the other hand, if there is a new USB device manufacturer looking to get a VID, one preferred option for doing this is becoming a member of the USB-IF. The many benefits of being a member is the assignment of a VID to the USB device manufacturer, though the annual membership fee is US$5,000.

In summary, to make the device manager of the operating system show the USB device by a customized serial port name like supplier name, there three works that the supplier of the USB device needs to compete in advance:
(1) becoming, by submitting a member application and paying the membership fee, a member of the USB-IF so as to get at least one VID;
(2) resubmitting, after revising the VID and/or PID listed in the “Strings” section of the *.inf file, the USB device driver package including the revised *.inf file to the Windows Hardware Dev Center for a new digital signature;
(3) enclosing, after re-publishing a *.cat file with the new digital signature, the re-published *.cat file, the *.inf file and the *.sys file as an updated USB device driver package.

However, it is not difficult to realize that spending thousands of dollars for completing the foregoing first and second works is still a significant financial expenditure for those small-sized enterprises. On the other hand, the starting number and the last number of the serial COM ports that the device manager of the commercial operating system (i.e., Windows) commonly assigns the RS232 connectors are 3 and 256, respectively. However, there are user's particular needs of assigning the RS 232 connectors a sequential number in a range between 1 and 65535.

According to above descriptions, it is understood that there is room for improvement in the USB-UART conversion device 1a of FIG. 1 and the UART expansion card 1b of FIG. 2. In view of that, inventors of the present application have made great efforts to make inventive research and eventually provided a bridge module, a UART expansion device, and a method of showing customized serial port name.

### SUMMARY OF THE INVENTION

The primary objective of the present invention is to provide a bridge module which comprises a bridge electronic chip and a memory, and is applied in the manufacture of a UART expansion device like USB-RS232 conversion device. According to the present invention, user is allowed to program a writing data including a customized serial port name into the memory. As such, when the UART expansion device is electrically connected to a host electronic device been installed with a corresponding driver of the UART expansion device, the bridge electronic chip reads out the customized serial port name from the memory, and then integrates the customized serial port name in a device descriptor, thereby transmitting the device descriptor to the host electronic device. As a result, a device manager of an operating system (e.g., Windows) of the host electronic device shows at least one UART port of the UART expansion device by the customized serial port name.

In addition, the user is further allowed to include a writing data including both the customized serial port name and a customized serial port sequential number into the memory, thereby making the device manager of the operating system assign the UART port of the UART expansion device the customized serial port sequential number, instead of the default serial COM port number.

To be more specific, the UART expansion device having the bridge module according to the present invention includes following merits:
(1) to make a device manager of an operating system of a personal computer show a USB-UART expansion device by a customized serial port name like supplier name, the work what the supplier or the user needs to do is only programming a writing data including the customized serial port name into the memory of the bridge module. In other words, the supplier does not need to revise VID and/or PID listed in an instruction section of “Strings” that is planned in a *.inf file of the device driver of the USB-UART expansion device, not to mention revising VID and/or PID would lead the digital signature of the device driver of the USB-UART expansion device to be invalid.
(2) supplier and/or manufacturer of the USB-UART conversion device do not need to, for becoming a member of the USB-IF so as to get VID thereof, submit a member application and pay the membership fee to the USB-IF, thereby saving the financial expenditure of thousands of dollars.
(3) supplier and/or manufacturer of the USB-UART conversion device do not need to resubmit USB device driver package including the revised *.inf file to the Windows Hardware Dev Center for a new digital signature that is adapted in re-publishing a *.cat file so as to enclose the re-published *.cat file, the *.inf file and the *.sys file as an updated USB device driver package, thereby saving the financial expenditure of WHQL test fee.
(4) by storing the customized serial port sequential number in the memory of the bridge module, the serial COM port number of the UART port of the USB-UART expansion device can be any one number in a range between 1 and 65535, instead of being limited to be in the range of 3-256.

In order to achieve the aforementioned objective, one embodiment of the bridge module is provided, which is adapted to be disposed on a circuit board that is provided with a signal interface and at least one UART interface thereon, such that the bridge module, the circuit board, the signal interface, and at least one UART interface constitute a UART expansion device; the bridge module comprises:
a bridge electronic chip, being coupled between the UART interface and the signal interface; and
a memory, being coupled to the bridge electronic chip, and storing a customized serial port name;
wherein the bridge electronic chip is configured so as to conduct:
reading out, in case of the signal interface being connected to a host electronic device that has been installed with a driver of the UART expansion device, the customized serial port name from the memory;
transmitting, after integrating the customized serial port name in a device descriptor, the device descriptor to the host electronic device;
transmitting, in case of the UART interface being in connection with an electronic device, a first UART signal that is converted from a first signal received from the signal interface to the electronic device; and
transmitting, in case of the electronic device transmitting a second UART signal to the UART interface, a second signal that is converted from the second UART signal to the host electronic device through the signal interface.

In one embodiment, the memory further stores a customized serial port sequential number, and the bridge electronic chip is further configured so as to conduct:
reading out, in case of the signal interface being connected to the host electronic device that has been installed with the driver of the UART expansion device, the customized serial port name and the customized serial port sequential number from the memory; and
transmitting, after integrating the customized serial port name and the customized serial port sequential number in the device descriptor, the device descriptor to the host electronic device.

In one embodiment, the bridge electronic chip is selected from a group consisting of USB-UART bridge electronic chip and USB-PCIe bridge electronic chip.

In one embodiment, the bridge electronic chip is selected from a group consisting of integrated circuit (IC) chip, complex programmable logic device (CPLD) chip, and field programmable gate array (FPGA) chip.

In one embodiment, the memory is selected from a group consisting of one-time programmable (OTP) memory, multi-time programmable (MTP) memory, electrically-erasable programmable read-only memory (EEPROM), and flash memory.

In one embodiment, the UART interface comprises at least one selected from a group consisting of RS232 connector, RS422 connector, and RS485 connector.

Moreover, an embodiment of a UART expansion device having a function of being changed a serial port name thereof to be customized is also provided, wherein the UART expansion device comprises:
a circuit board;
a signal interface, being disposed on the circuit board;
at least one UART interface, being disposed on the circuit board; and
a bridge module, being disposed on the circuit board, and comprising a bridge electronic chip and a memory coupled to the bridge electronic chip;
wherein the bridge electronic chip is coupled between the signal interface and the UART interface, and the memory storing a customized serial port name;
wherein the bridge electronic chip is configured so as to conduct:
reading out, in case of the signal interface being connected to a host electronic device that has been installed with a driver of the UART expansion device, the customized serial port name from the memory;
transmitting, after integrating the customized serial port name in a device descriptor, the device descriptor to the host electronic device;
transmitting, in case of the UART interface being in connection with an electronic device, a first UART signal that is converted from a first signal received from the signal interface to the electronic device; and
transmitting, in case of the electronic device transmitting a second UART signal to the UART interface, a second signal that is converted from the second UART signal to the host electronic device through the signal interface.

In one embodiment, the memory further stores a customized serial port sequential number, and the bridge electronic chip is further configured so as to conduct:
reading out, in case of the signal interface being connected to the host electronic device that has been installed with the driver of the UART expansion device, the customized serial port name and the customized serial port sequential number from the memory; and
transmitting, after integrating the customized serial port name and the customized serial port sequential number in the device descriptor, the device descriptor to the host electronic device.

In one embodiment, the bridge electronic chip is selected from a group consisting of USB-UART bridge electronic chip and USB-PCIe bridge electronic chip.

In one embodiment, the bridge electronic chip is selected from a group consisting of integrated circuit (IC) chip, complex programmable logic device (CPLD) chip, and field programmable gate array (FPGA) chip.

In one embodiment, the memory is selected from a group consisting of one-time programmable (OTP) memory, multi-time programmable (MTP) memory, electrically-erasable programmable read-only memory (EEPROM), and flash memory.

In one embodiment, the UART interface comprises at least one selected from a group consisting of RS232 connector, RS422 connector, and RS485 connector.

Furthermore, a method of showing customized serial port name, comprising:
further integrating, a memory into a UART expansion device that comprising a signal interface, at least one UART interface and a bridge electronic chip coupled between the signal interface and the at least one UART interface;
making, the memory be coupled to the bridge electronic chip;
installing, after the signal interface being connected to a host electronic device, a driver of the UART expansion device in the host electronic device; and
configurating the bridge electronic chip to conduct:
programming, after receiving a writing data including a customized serial port name from the host electronic device, the writing data into the memory;
reading out, in case of the memory storing customized serial port name as well as the signal interface being connected the host electronic device, the customized serial port name from the memory; and
transmitting, after integrating the customized serial port name in a device descriptor, the device descriptor to the host electronic device.

In one embodiment, the method further comprises:
installing, an application program in the host electronic device, such that a plurality of operations comprising editing the writing data and programming the writing data into the memory are able to be conducted by executing the application program.

In one embodiment, the method further comprises:
further including, by executing and operating the application program, a customized serial port sequential number into the writing data.

In one embodiment, the memory further stores the customized serial port sequential number, and the bridge electronic chip is further configured so as to conduct:
reading out, in case of the signal interface being connected to the host electronic device that has been installed with the driver of the UART expansion device, the customized serial port name and the customized serial port sequential number from the memory; and
transmitting, after integrating the customized serial port name and the customized serial port sequential number in the device descriptor, the device descriptor to the host electronic device.

In one embodiment, the bridge electronic chip is selected from a group consisting of USB-UART bridge electronic chip and USB-PCIe bridge electronic chip.

In one embodiment, the bridge electronic chip is selected from a group consisting of integrated circuit (IC) chip, complex programmable logic device (CPLD) chip, and field programmable gate array (FPGA) chip.

In one embodiment, the memory is selected from a group consisting of one-time programmable (OTP) memory, multi-time programmable (MTP) memory, electrically-erasable programmable read-only memory (EEPROM), and flash memory.

In one embodiment, the UART interface comprises at least one selected from a group consisting of RS232 connector, RS422 connector, and RS485 connector.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a stereo diagram of a conventional USB-UART conversion device.

FIG. 2 shows a stereo diagram of a conventional UART expansion card.

FIG. 3 shows a user interface of a device manager of an operating system of a personal computer that is installed with a standard device driver.

FIG. 4 shows the user interface of the device manager of the personal computer that is installed with a manufacturer-developed device driver.

FIG. 5 shows a stereo diagram of a USB-UART conversion device including a bridge module according to the present invention.

FIG. 6 shows a stereo diagram of a UART expansion card including the bridge module according to the present invention.

FIG. 7 a user interface of a device manager of an operating system of a host electronic device as shown in FIG. 5.

### DETAILED DESCRIPTION OF THE PREFERRED EMBODIMENTS

To more clearly describe a bridge module, a UART expansion device, and a method of showing customized serial port name according to the present invention, embodiments of the present invention will be described in detail with reference to the attached drawings hereinafter.

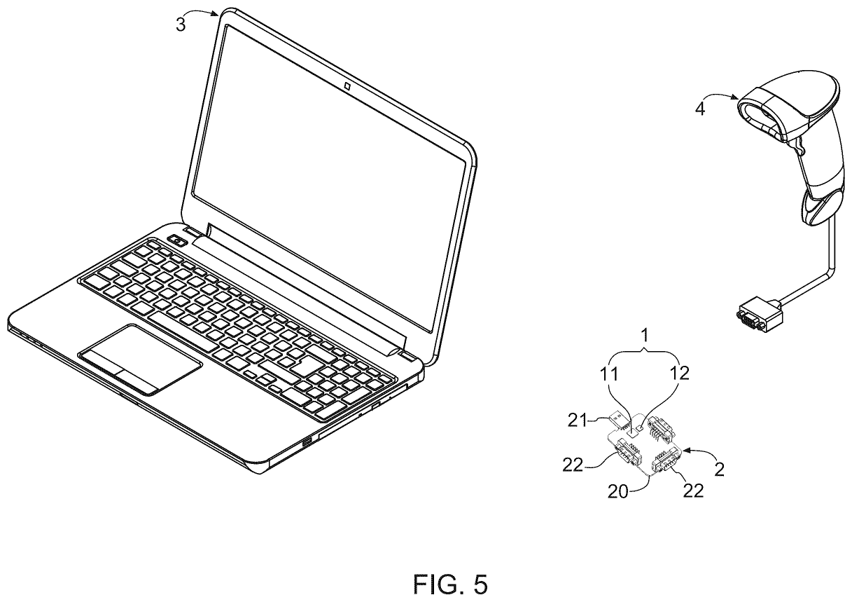

In the present invention, a bridge module 1 is disclosed that is adapted to be disposed on a circuit board that is provided with a signal interface and at least one UART interface thereon, such that the bridge module, the circuit board, the signal interface, and at least one UART interface constitute a UART expansion device. For example, FIG. 5 illustrates a stereo diagram of a USB-UART conversion device including the bridge module according to the present invention. As FIG. 5 shows, the USB-UART conversion device 2, one kind of UART expansion device, comprises a circuit board 20, a signal interface 21, a UART interface 22 comprising three RS232 connectors, and the bridge module 1 according to the present invention. To be more specific, the bridge module 1 comprises a bridge electronic chip 11 coupled between the UART interface 22 and the signal interface 21, and further comprises a memory 12 which is coupled to the bridge electronic chip 11 and stores a customized serial port name. In a practical embodiment, the USB-UART conversion device 2 is an external UART expansion device, and is arranged to become one peripheral device of a host electronic device 4 by connecting the signal interface (i.e., USB connector) 21 to one USB connector of the host electronic device 4. Besides, the bridge electronic chip 11 can be a Prolific PL2303 chip, i.e., one kind of USB-UART bridge IC.

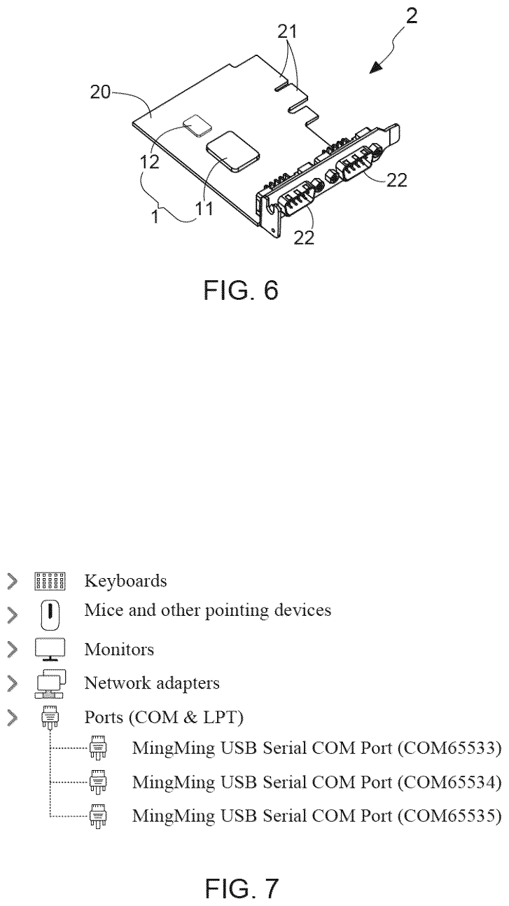

On the other hand, FIG. 6 illustrates a stereo diagram of a UART expansion card including the bridge module. As FIG. 6 shows, the UART expansion card 3, another one kind of UART expansion device, comprises a circuit board 30, a signal interface (i.e., golden fingers) 31, a UART interface 32 comprising three RS232 connectors, and the bridge module 1 according to the present invention. To be more specific, the signal interface 31 is adapted for being inserted into a PCIe slot that is disposed on a mother board of the host electronic device 4, such that the installing of the UART expansion card 3 in the host electronic device 4 is completed. Moreover, in this case the bridge electronic chip 11 is a USB-PCIe bridge IC.

As described in more detail below, the memory can be, but is not limited to one-time programmable (OTP) memory, multi-time programmable (MTP) memory, electrically-erasable programmable read-only memory (EEPROM), or flash memory. On the other hand, the bridge electronic chip can be, but is not limited to integrated circuit (IC) chip, complex programmable logic device (CPLD) chip, or field programmable gate array (FPGA) chip. Taking the USB-UART conversion device 2 of FIG. 5 as an example of UART expansion device, according to the present invention there are intrusions programmed in an internal memory of the bridge electronic chip 11 or an external memory that is coupled to the bridge electronic chip 11. As such, after the bridge module 1 is powered on, the bridge electronic chip 11 executes the instructions so as to be configured to perform following functions:
reading out, in case of the signal interface 21 being connected to a host electronic device 4 that has been installed with a manufactured-developed driver of the UART expansion device (i.e., the USB-UART conversion device 2), the customized serial port name from the memory 12;
transmitting, after integrating the customized serial port name in a device descriptor, the device descriptor to the host electronic device 4;
transmitting, in case of the UART interface 22 being in connection with an electronic device 5 like barcode scanner, a first UART signal that is converted from a first signal (e.g., USB signal or PCIe signal) received from the signal interface 21 to the electronic device 5; and
transmitting, in case of the electronic device transmitting a second UART signal to the UART interface 22, a second signal (e.g., USB signal or PCIe signal) that is converted from the second UART signal to the host electronic device 4 through the signal interface 21.

To be more specific, manufacturer of the UART expansion device like the USB-UART conversion device 2 of FIG. 5 needs to develop so as to provide, based on a standard CDC-ACM driver provided by Microsoft Corporation, the aforesaid manufacturer-developed device driver of the USB-UART conversion device 2. In other words, the user needs to install the manufacturer-developed device driver in his computer (i.e., the host electronic device 4) after firstly connecting the USB connector (i.e., the signal interface) of the USB-UART conversion device 2 to one USB connector of the host electronic device 4. Therefore, as FIG. 4 shows, in a user interface of a device manager of an operating system of the host electronic device 4, it can see that the three RS232 ports of the UART interface 22 of the USB-UART conversion device 2 are all named as Prolific PL2303GC USB Serial COM Port, and the device manager assigns the three RS232 ports corresponding serial port numbers of 3, 4, 5. It is worth further explaining that, a USB device driver (e.g., the aforesaid manufacturer-developed device driver) comprises a *.inf file and a *.sys file, of which the *.sys file includes the principal driver instructions, and the *.inf is a device information file for use in guiding the operating system of the host electronic device 4 to run the whole install procedure of the USB device driver. In addition, there is an instruction section named as “Strings” planned and edited in the *.inf file, and the USB device's VID and PID are listed in this instruction section, such that the operating system can read the *.inf file so as to acquire VID and PID of the USB-UART conversion device 2 while running the install procedure of the USB device driver. Therefore, it is understood that “Prolific” and “PL2303GE” are VID and PID of the bridge IC 10a with reference to FIG. 4.

Particularly, to make the device manager of the operating system of the host electronic device 4 show the three RS232 ports of the UART interface 22 of the USB-UART expansion device 2 by a customized serial port name like supplier name or a user-designated name, the work what the supplier or the user needs to do is only programming a writing data including the customized serial port name into the memory 12 of the bridge module 1. In other words, the supplier does not need to revise VID and/or PID listed in the “Strings” section of the *.inf file that is included in the manufactured-developed device driver of the USB-UART expansion device 2, not to mention revising VID and/or PID would lead the digital signature of the manufactured-developed device driver to be invalid. To be more specific, the supplier or the user needs to install an application program in the host electronic device 4, such that a plurality of operations comprising editing the writing data and programming the writing data into the memory 12 are able to be conducted by executing the application program.

It is worth further explaining that, the UART interface 22 is not limited to contain the three RS232 connectors with reference to FIG. 5, but can also be arranged to include at least one RS422 connector and/or at least one RS485 connector. On the other hand, the starting number and the last number of the serial COM ports that the device manager of the operating system (i.e., Windows) of the host electronic device 4 commonly assigns the RS 232 connector of the UART interface 22 are 3 and 256, respectively. However, there are user's particular needs of assigning the RS232 connectors a sequential number in a range between 1 and 65535. To make the device manager of the operating system assigns the RS232 port of the UART interface 22 of the USB-UART conversion device 2 a customized serial port sequential number, the work what the supplier or the user needs to do is, by operating the application program, editing the writing data to further include a customized serial port sequential number and then programming the writing data into the memory 12 of the bridge module 1. As such, the customized serial port name and the customized serial port sequential number stored in the memory 12 would be read out by the bridge electronic chip 11, and then are integrated in the device descriptor for further being transmitted to the host electronic device 4. As a result, the device manager of the operating system assigns the RS232 port of the UART interface 22 of the USB-UART conversion device 2 the customized serial port sequential number, instead of the default serial COM port number.

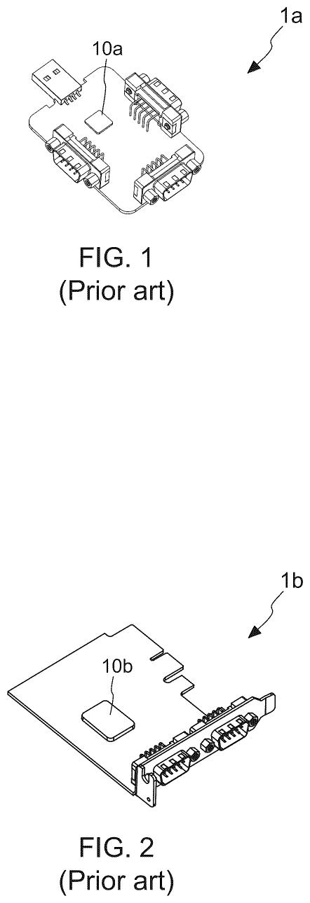

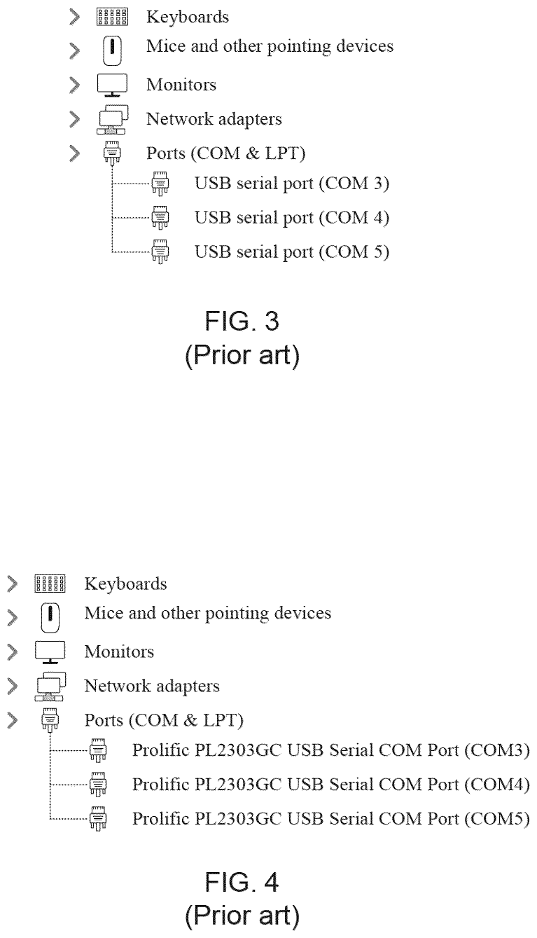

Briefly speaking, the conventional UART expansion device such as the USB-UART conversion device of FIG. 1 or the UART expansion card of FIG. 2 commonly comprises a circuit board, a bridge IC, a signal interface, and a UART interface, and not has the function of being changed a serial port name thereof to be customized. Differing from the conventional UART expansion device, the UART expansion device of the present invention like the USB-UART conversion device 2 with reference to FIG. 5 comprises a circuit board 20, a signal interface 21, a UART interface 22, and a bridge module 1 consisting of a bridge electronic chip 11 and a memory 12, where the memory 12 is adapted for storing a customized serial port name and a customized serial port sequential number, such that the UART expansion device of the present invention like the USB-UART conversion device 2 with reference to FIG. 5 having a function of being changed a serial port name thereof to be customized.

After connecting the USB connector of the signal interface 21 to one USB connector of the host electronic device 4 as well as installing an application program in the host electronic device 4, the supplier or the user is able to make, by operating the application program to edit the writing data to further include a customized serial port sequential number and then program the writing data into the memory 12 of the bridge module 1, the device manager of the operating system assigns the RS232 port of the UART interface 22 of the USB-UART conversion device 2 the customized serial port sequential number in a range between 1 and 65535, instead of being limited to be in the range of 3-256.

FIG. 7 illustrate the user interface of the device manager of the operating system of the host electronic device 4 as shown in FIG. 5. As FIG. 7 shows, in the user interface of the device manager of the operating system it can see that the three RS232 ports of the USB-UART conversion device 2 are all named as “MingMing USB Serial COM Port”, and the device manager assigns the three RS232 ports corresponding serial port numbers of 65533, 65534 and 65535.

Therefore, in above descriptions, the bridge module 1 according to the present invention has been introduced completely and clearly. Moreover, the UART expansion device, such as the USB-UART conversion device 2 of FIG. 5 and the UART expansion card 3 of FIG. 6, including the bridge module 1 so as to have a function of being changed a serial port name thereof to be customized has also been introduced completely and clearly. In addition, in this specification a method of showing customized serial port name is also introduced completely and clearly.

To be particularly emphasized that, the above description is made on embodiments of the present invention. However, the embodiments are not intended to limit scope of the present invention, and all equivalent implementations or alterations within the spirit of the present invention still fall within the scope of the present invention.

What is claimed is:

1. A bridge module, being adapted to be disposed on a circuit board that is provided with a signal interface and at least one UART interface thereon, such that the bridge module, the circuit board, the signal interface, and at least one UART interface constitute a UART expansion device; the bridge module comprising:
a bridge electronic chip, being coupled between the UART interface and the signal interface; and
a memory, being coupled to the bridge electronic chip, and storing a customized serial port name;
wherein the bridge electronic chip is configured so as to conduct:
reading out, in case of the signal interface being connected to a host electronic device that has been installed with a driver of the UART expansion device, the customized serial port name from the memory;
transmitting, after integrating the customized serial port name in a device descriptor, the device descriptor to the host electronic device;
transmitting, in case of the UART interface being in connection with an electronic device, a first UART signal that is converted from a first signal received from the signal interface to the electronic device; and
transmitting, in case of the electronic device transmitting a second UART signal to the UART interface, a second signal that is converted from the second UART signal to the host electronic device through the signal interface.

2. The bridge module of claim 1, wherein the memory further stores a customized serial port sequential number, and the bridge electronic chip being further configured so as to conduct:
reading out, in case of the signal interface being connected to the host electronic device that has been installed with the driver of the UART expansion device, the customized serial port name and the customized serial port sequential number from the memory; and
transmitting, after integrating the customized serial port name and the customized serial port sequential number in the device descriptor, the device descriptor to the host electronic device.

3. The bridge module of claim 1, wherein the bridge electronic chip is selected from a group consisting of USB-UART bridge electronic chip and USB-PCIe bridge electronic chip.

4. The bridge module of claim 1, wherein the bridge electronic chip is selected from a group consisting of integrated circuit (IC) chip, complex programmable logic device (CPLD) chip, and field programmable gate array (FPGA) chip.

5. The bridge module of claim 1, wherein the memory is selected from a group consisting of one-time programmable (OTP) memory, multi-time programmable (MTP) memory, electrically-erasable programmable read-only memory (EEPROM), and flash memory.

6. The bridge module of claim 1, wherein the UART interface comprises at least one selected from a group consisting of RS232 connector, RS422 connector, and RS485 connector.

7. A UART expansion device having a function of being changed a serial port name thereof to be customized, comprising:
a circuit board;
a signal interface, being disposed on the circuit board;
at least one UART interface, being disposed on the circuit board; and
a bridge module, being disposed on the circuit board, and comprising a bridge electronic chip and a memory coupled to the bridge electronic chip;
wherein the bridge electronic chip is coupled between the signal interface and the UART interface, and the memory storing a customized serial port name;
wherein the bridge electronic chip is configured so as to conduct:
reading out, in case of the signal interface being connected to a host electronic device that has been installed with a driver of the UART expansion device, the customized serial port name from the memory;
transmitting, after integrating the customized serial port name in a device descriptor, the device descriptor to the host electronic device;
transmitting, in case of the UART interface being in connection with an electronic device, a first UART signal that is converted from a first signal received from the signal interface to the electronic device; and
transmitting, in case of the electronic device transmitting a second UART signal to the UART interface, a second signal that is converted from the second UART signal to the host electronic device through the signal interface.

8. The UART expansion device of claim 7, wherein the memory further stores a customized serial port sequential number, and the bridge electronic chip is further configured so as to conduct:
reading out, in case of the signal interface being connected to the host electronic device that has been installed with the driver of the UART expansion device, the customized serial port name and the customized serial port sequential number from the memory; and
transmitting, after integrating the customized serial port name and the customized serial port sequential number in the device descriptor, the device descriptor to the host electronic device.

9. The UART expansion device of claim 7, wherein the bridge electronic chip is selected from a group consisting of USB-UART bridge electronic chip and USB-PCIe bridge electronic chip.

10. The UART expansion device of claim 7, wherein the bridge electronic chip is selected from a group consisting of integrated circuit (IC) chip, complex programmable logic device (CPLD) chip, and field programmable gate array (FPGA) chip.

11. The UART expansion device of claim 7, wherein the memory is selected from a group consisting of one-time programmable (OTP) memory, multi-time programmable (MTP) memory, electrically-erasable programmable read-only memory (EEPROM), and flash memory.

12. The UART expansion device of claim 7, wherein the UART interface comprises at least one selected from a group consisting of RS232 connector, RS422 connector, and RS485 connector.

13. A method of showing customized serial port name, comprising:
further integrating, a memory into a UART expansion device that comprising a signal interface, at least one UART interface and a bridge electronic chip coupled between the signal interface and the at least one UART interface;
making, the memory be coupled to the bridge electronic chip;
installing, after the signal interface being connected to a host electronic device, a driver of the UART expansion device in the host electronic device; and
configurating the bridge electronic chip to conduct:
programming, after receiving a writing data including a customized serial port name from the host electronic device, the writing data into the memory;
reading out, in case of the memory storing customized serial port name as well as the signal interface being connected the host electronic device, the customized serial port name from the memory; and
transmitting, after integrating the customized serial port name in a device descriptor, the device descriptor to the host electronic device.

14. The method of claim 13, further comprising:
installing, an application program in the host electronic device, such that a plurality of operations comprising editing the writing data and programming the writing data into the memory are able to be conducted by executing the application program.

15. The method of claim 14, further comprising:
further including, by executing and operating the application program, a customized serial port sequential number into the writing data.

16. The method of claim 15, where the memory further stores the customized serial port sequential number, and the bridge electronic chip being further configured so as to conduct:
reading out, in case of the signal interface being connected to the host electronic device that has been installed with the driver of the UART expansion device, the customized serial port name and the customized serial port sequential number from the memory; and
transmitting, after integrating the customized serial port name and the customized serial port sequential number in the device descriptor, the device descriptor to the host electronic device.

17. The method of claim 13, wherein the bridge electronic chip is selected from a group consisting of USB-UART bridge electronic chip and USB-PCIe bridge electronic chip.

18. The method of claim 13, wherein the bridge electronic chip is selected from a group consisting of integrated circuit (IC) chip, complex programmable logic device (CPLD) chip, and field programmable gate array (FPGA) chip.

19. The method of claim 13, wherein the memory is selected from a group consisting of one-time programmable (OTP) memory, multi-time programmable (MTP) memory, electrically-erasable programmable read-only memory (EEPROM), and flash memory.

20. The method of claim 13, wherein the UART interface comprises at least one selected from a group consisting of RS232 connector, RS422 connector, and RS485 connector.
